(19) United States
(12) Patent Application Publication
(10) Pub. No.: US 2024/0100421 A1
(43) Pub. Date: Mar. 28, 2024

(54) INPUT DEVICE, CONTROLLER AND METHOD

(71) Applicant: Sony Interactive Entertainment Inc., Tokyo (JP)

(72) Inventors: Rajeev Gupta, London (GB); Navin Kamath, London (GB); Calum Armstrong, London (GB); Nima Karshenas, London (GB); Daniele Bernabei, London (GB)

(73) Assignee: Sony Interactive Entertainment Inc., Tokyo (JP)

(21) Appl. No.: 18/468,872

(22) Filed: Sep. 18, 2023

(30) Foreign Application Priority Data
Sep. 22, 2022 (GB) 2213845.7

(51) Int. Cl. A63F 13/31; A63F 13/24

(52) U.S. Cl. CPC A63F 13/31; A63F 13/24

(57) ABSTRACT

An input device for controlling a computing system includes one or more sensors configured to sense a change in weight distribution of a user positioned on the input device in use, and a transmitter configured to transmit a signal based on the sensed change in weight distribution, for use in a virtual joystick input to a computing system.

### FIELD

The present invention relates to computer input devices, controllers and related methods. More particularly, but not exclusively, the present invention relates to an input device or controller and related methods for controlling a computing or entertainment system, providing one or more virtual inputs based on sensed movement of a user.

Even with the recent advances in performance capture (i.e., tracking of a system user's motion to induce a corresponding effect on a displayed graphic), a handheld controller with a control stick (or joystick) remains the most popular input device for the electronic game industry.

FIG. 1 depicts a Sony DualShock 4® handheld controller 100 commercially available for a Sony PlayStation® series of electronic gaming platforms. The handheld controller 100 includes dual thumb sticks 105 protruding from the controller body 101. Each thumb stick 105 provides a two-dimensional input (x, y) which may be used to induce a corresponding effect on a displayed graphic. Each thumb stick 105, sometimes called an analogue stick or more generally a control stick or joystick, provides positional input to a computing platform based on the position of the protrusion relative to a mechanical “centre” position within the controller body 101. During use, a user's thumb (or other digit) typically rests on a top surface of each thumb stick 105 and pressure applied by the thumb may change the displacement of the thumb stick 105 relative to the centre position, which may serve as a reference position. A pivoting base of each thumb stick 105 is coupled to two or more potentiometers housed within the controller body 101 to provide a continuous electrical output proportional to the displacement of the thumb stick 105 relative to the central reference position (hence, the term “analogue stick”).

Referring to FIG. 2, an example of an entertainment system 10 is a computer or console such as the Sony® PlayStation 5 ® (PS5). The entertainment system 10 comprises a central processor unit (CPU) 20. This may be a single or multi core processor, for example comprising eight cores as in the PS5. The entertainment system 10 also comprises a graphical processing unit or GPU 30. The GPU can be physically separate to the CPU, or integrated with the CPU as a system on a chip (SoC) as in the PS5.

The entertainment system 10 also comprises RAM 40, and may either have separate RAM for each of the CPU and GPU, or shared RAM as in the PS5. The or each RAM can be physically separate, or integrated as part of an SoC as in the PS5. Further storage is provided by a disk 50, either as an external or internal hard drive, or as an external solid state drive, or an internal solid state drive as in the PS5.

The entertainment system 10 may transmit or receive data via one or more data ports 60, such as a USB port, Ethernet® port, WiFi® port, Bluetooth® port or similar, as appropriate. It may also optionally receive data via an optical drive 70.

Interaction with the system is typically provided using one or more handheld controllers, such as the DualSense® controller 80 in the case of the PS5. Such a controller typically has two handle sections 81L,R and a central body 81C. Various controls are distributed over the controller, typically in local groups. Examples include a left button group 82L, which may comprise directional controls and/or one or more shoulder buttons, and similarly right button group 82R, which comprise function controls and/or one or more shoulder buttons. The controller also includes left and/or right joysticks or thumb sticks 84L,R, which may optionally also be operable as buttons by pressing down on them.

The controller 80 (typically in the central portion of the device) may also comprise one or more system buttons 86, which typically cause interaction with an operating system of the entertainment system 10 rather than with a game or other application currently running on it; such buttons may summon a system menu, or allow for recording or sharing of displayed content. Furthermore, the controller may comprise one or more other elements such as a touchpad 88, a light for optical tracking (not shown), a screen (not shown), haptic feedback elements (not shown), and the like.

Audio/visual outputs from the entertainment system 10 are typically provided through one or more A/V ports 90, or through one or more of the wired or wireless data ports 60. Where components are not integrated, they may be connected as appropriate either by a dedicated data link or via a bus 100. An example of a device for displaying images output by the entertainment system 10 is a head mounted display ‘HMD’ 802, worn by a user 800.

While the control afforded by the continuous nature of the thumb stick has made it a popular input means for handheld controllers (particularly for 3D games), such a control system is not suitable for all users, particularly those who cannot hold a standard controller and/or who suffer from reduced motor control, involuntary movements, chronic pain, joint disorders and/or injury. Means and techniques to improve accessibility to and/or input sensitivity, accuracy, functionality or responsiveness of computer input devices and controllers are therefore advantageous.

WO2018224801A1, incorporated herein by reference, discloses computer input devices and more particularly a handheld controller employing one or more control sticks.

### BRIEF DESCRIPTION OF THE INVENTION

The present invention provides an input device for controlling a computing system, comprising one or more sensors configured to sense a change in weight distribution of a user positioned on the input device in use, and a transmitter configured to transmit a signal based on the sensed change in weight distribution, for use in a virtual joystick input to a computing system.

The present invention further provides an input device for controlling a computing system, comprising one or more sensors configured to sense a change in weight distribution of a user positioned on the input device in use; and a controller configured to determine a virtual joystick input based on the sensed change in weight distribution and provide the virtual joystick input to a computing system.

The present invention further provides a controller for controlling a computing system based on a signal from an input device, the controller configured to: receive a signal based on a sensed change in weight distribution from an input device comprising one or more sensors configured to sense a change in weight distribution of a user positioned on the input device in use; determine a virtual joystick input based on the signal; and provide the virtual joystick input to the computing system.

The present invention further provides a method for controlling a computing system based on a change in weight distribution of a user, comprising: at an input device having one or more sensors configured to sense a change in weight distribution of a user positioned on the input device in use, sensing a change in weight distribution of a user positioned on the input device in use; and transmitting a signal based on the sensed change in weight distribution, for use in a virtual joystick input to a computing system.

The present invention further provides a method of determining a virtual joystick input based on a change in weight distribution of a user, for controlling a computing system, comprising: receiving a signal based on a sensed change in weight distribution from an input device comprising one or more sensors configured to sense a change in weight distribution of a user positioned on the input device in use; determining a virtual joystick input based on the signal; and providing the virtual joystick input to the computing system.

Further aspects and features of the invention are defined in the dependent claims.

The present invention seeks to improve the accessibility, sensitivity, accuracy and/or responsiveness of computer input devices and controllers by determining a virtual joystick input 241 based on sensed movement of a user to emulate the functionality of a handheld controller with a control stick, via the user altering their weight distribution or centre of gravity, particularly by the user leaning in one or more directions. The invention allows a user to use their body like a joystick, i.e. changing the position/weight distribution/centre of gravity of all or part of their body to provide a joystick input. The joystick input can be used in isolation or in conjunction with any other inputs, which may be movable to suit an individual user.

In the claims, the term ‘controller’ is used in the broadest sense, particularly in reference to a computer-based controller or a processor, and not necessarily a physical handheld controller such as the DualSense® handheld controller of the PS5.

### BRIEF DESCRIPTION OF THE DRAWINGS

Embodiments of the present invention will now be described by way of example only, with reference to the accompanying drawings, in which:

FIG. 1 illustrates an isometric view of a conventional handheld electronic game controller.

FIG. 2 illustrates a schematic view of an example entertainment computing system 10 such as the Sony® PlayStation 5 ® (PS5).

FIG. 3 illustrates a schematic diagram of a system comprising an input device, a controller and a computing system in accordance with an embodiment of the present invention.

FIG. 4 illustrates a more detailed schematic diagram of the system of FIG. 3 in accordance with an embodiment of the present invention.

FIG. 5 illustrates a schematic diagram of how the system of FIGS. 3 and 4 may be calibrated and used to provide an input in accordance with an embodiment of the present invention.

For clarity of illustration, elements illustrated in the figures have not necessarily been drawn to scale. Further, where considered appropriate, reference numerals have been repeated among the figures to indicate corresponding or analogous elements.

### DETAILED DESCRIPTION

The terms “coupled” and “connected,” along with their derivatives, may be used herein to describe structural relationships between components of the apparatus or system for performing the operations herein. It should be understood that these terms are not intended as synonyms for each other. Rather, in particular embodiments, “connected” is used to indicate that two or more elements are in direct physical or electrical contact with each other while “coupled” is used to indicate two or more elements are in either direct or indirect (with other intervening elements between them) physical or electrical contact with each other, and/or that the two or more elements co-operate or communicate with each other (e.g., as in a cause and effect relationship).

In the following description, a number of specific details are presented in order to provide a thorough understanding of embodiments of the present disclosure. It will be apparent, however, to a person skilled in the art that these specific details need not be employed to practice the invention. Conversely, specific details known to the person skilled in the art are omitted for the purposes of clarity where appropriate.

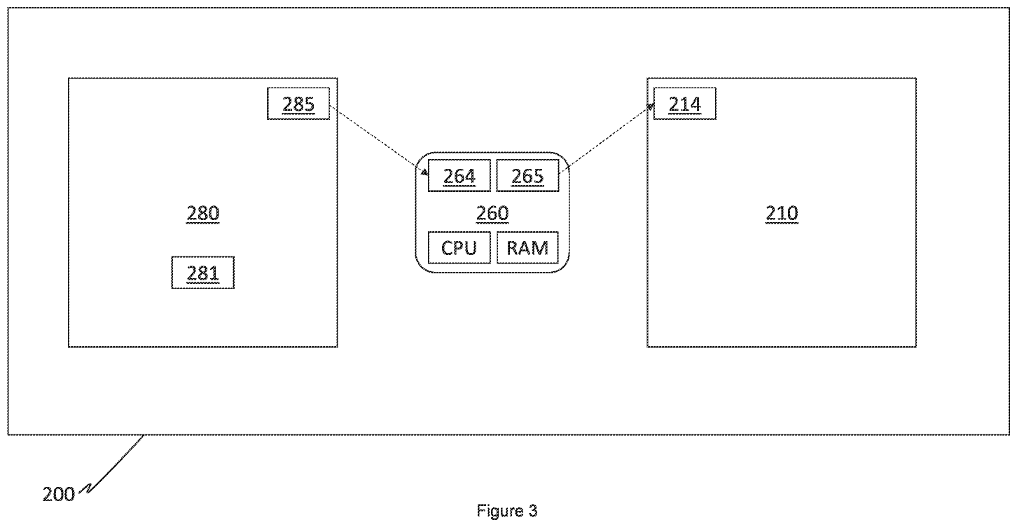

FIG. 3 illustrates a schematic diagram of a system 200 comprising an input device 280, a controller 260 and a computing system 210, in accordance with an embodiment of the present invention.

The input device 280 comprises one or more sensors 281 that are configured to sense a change in weight distribution of a user positioned on the input device 280 in use and generate corresponding sensor data. Any suitable type of sensor may be used, such as, but not exclusively, a force or pressure sensor, such as a strain gauge. The input device 280 may be in the form of a mat, a seat (encompassing anything made or used for sitting on, such as a chair or stool), or a cushion or pad thereof or for placement on such a seat, or a bed, or any component thereof or fitting therefor, such as a seat pan, seat pad, seat leg, seat wheel, bed frame, bed frame leg, bed frame wheel or a mattress. In use, the user is positioned on the input device 280, preferably sat or lying thereon, or alternatively standing thereon.

The input device 280 further comprises a transmitter 285 configured to transmit data comprising a signal based on the sensed change in weight distribution, for use in a virtual joystick input 241 to a computing system. The transmitter 285 may take any form, such as electronic wiring or circuitry providing a data link or bus for transmitting the signal by wired or wireless communication means (such as Bluetooth® or Wi-Fi®) to a controller 260, which may be internal within the input device 280, or external, e.g. to the external controller 260 as shown in FIG. 3.

The (typically continuous) electrical sensor output data of the one or more sensors 281 can be transmitted raw or part-processed, e.g. input to one or more analogue-to-digital converters, ADCs, in order to determine one or more digital values indicative of the force or pressure on a given sensor, or a relative force or pressure change experienced by a given sensor, or a weight distribution of the user on the input device 280. For example, the controller 260 can determine a relative change in the force or pressure sensed by the sensor using an analogue-to-digital conversion of an observed change in capacitance, current and/or resistance associated with the sensor, depending on the type of sensor used. Alternatively, the controller 260 may receive a digital representation of the sensor output and apply a meaningful calibration to determine the applied force/pressure. Hence, the controller 260 is operable to provide a joystick input to the computing system 210, e.g. to update the game state of a game in response to that distinct input and corresponding image data is generated and output for a display device.

For an arrangement with a plurality of sensors 281, each sensor 281 can be assigned a sensor ID and the controller 260 is operable to respectively determine the data (e.g. force, pressure) sensed by each sensor 281 to establish the user's weight distribution and/or relative changes thereto, which can be selectively processed, e.g. summed or subjected to a weighted averaging, to determine the virtual joystick input 241.

In FIG. 3, the controller 260 provides an intermediary controller 260 between the input device 280 and the computing system 210. The controller 260 is configured to receive the signal based on the sensed change in weight distribution from the input device 260, determine a virtual joystick input 241 based on the received signal and then transmit or apply the virtual joystick input 241 to the computing system 210.

In some embodiments, the controller 260 can be configured to determine an absolute centre of gravity of the user based on the sensor data (effectively summing the moments of the user's weight and dividing by their overall weight, where the moment is the product of weight and distance from the reference origin point X₀, Y₀), or determine a relative weight distribution shift from a reference distribution or centre of gravity at X₀, Y₀ (e.g. shifting weight 10% forward and 5% left). Monitoring relative weight distribution shift is generally preferable, as it can be less computationally expensive and certain movements (such as tensing the glutes) might shift weight distribution, but not (or not significantly) a user's overall centre of gravity. As such, the controller 260 is configured to translate the received sensor signal data into a representation that can be transmitted to the computing system 210 as a meaningful input. As shown, the controller 260 may comprise a receiver 264, a CPU and/or RAM.

As noted above, the controller 260 in FIG. 3 is an intermediary controller 260 and so the controller 260 is configured to transmit data comprising the virtual joystick input 241 using a (controller) transmitter 265 to the (external) computing system 210, which is received by a receiver 214 in the computing system 210. The computing system 210 can then apply the virtual joystick input 241 received from the (intermediary) controller 260, for example when the computing system 210 is the PS5, then the PS5 processor is operable to update the state of the game responsive to the received data. Again, the same as for the input device transmitter 285, the controller transmitter 265 (and equally the complementary receivers 264, 214) may take any suitable form.

FIGS. 3 (and 4) illustrates the system 200 comprising an intermediary controller 260, but the skilled person will appreciate that the functionality of the controller 260 may be integrated within the input device 280 and/or the computing device 210. Thus, in some embodiments, the input device 280 comprises the controller 260 (or equivalent functionality); or the computing system 210 comprises the controller 260 (or equivalent functionality).

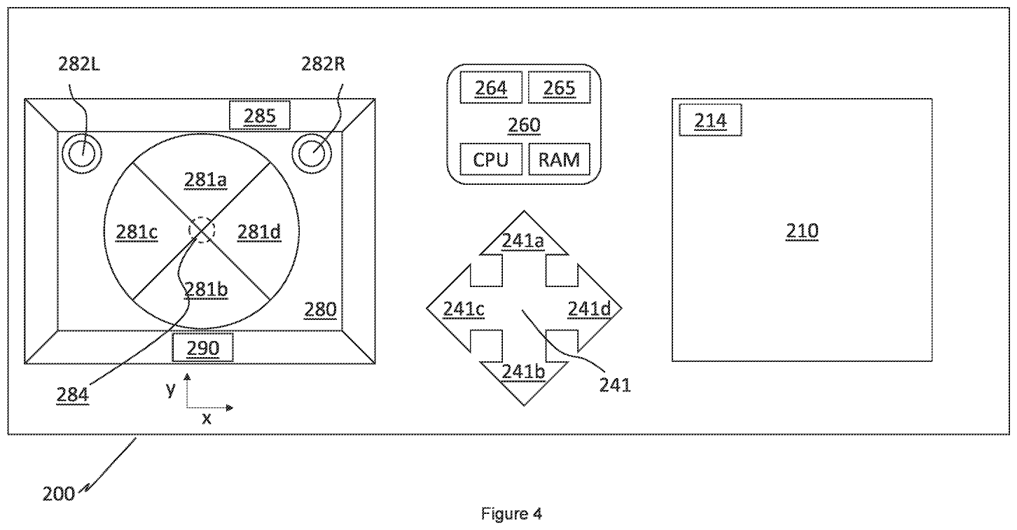

FIG. 4 illustrates a more detailed schematic diagram of the system of FIG. 3 in accordance with an embodiment of the present invention. Key additions to the embodiment of FIG. 3 are described herein. In particular, the input device 280 is in the form of a seat cushion 280 (e.g. either integral to a seat, or for placement on a seat), and comprises a central 2D array of 4 sensors 281a-281d arranged at 12 o'clock, 6 o'clock, 9 o'clock and 3 o'clock positions therein respectively, to detect changes in the user's weight in 4 different zones, corresponding to the 4 cardinal directions, and thereby sense a change in weight distribution of the user on the input device 280, e.g. as they lean in any direction, generating a directional weight bias. The sensors may be of any suitable type, such as a force sensor, a capacitance pressure sensor, resistance pressure sensor, piezoresistive pressure sensor, piezoelectric pressure sensor, optical pressure sensor, and/or an elastoresistive pressure sensor.

The input device 280 further comprises two input buttons 282L, R to provide action inputs to the computing system 210, corresponding to any action button such as any of the action buttons 82R of the handheld controller 80. Furthermore, the input device 280 additionally comprises a haptic feedback device 290, configured to provide haptic feedback to the user as they interact with the computing system 210 via the input device 280. The system may optionally comprise any number of additional input devices, actuators or haptic feedback devices, such as buttons and/or an additional joystick, steering or pointer (mouse) control device which may be used in conjunction with the weight distribution sensing system, particularly for users who typically can only control one directional input at a time. For example, the system may optionally comprise gross body motion buttons or controls, such as force/pressure pads on sides of the seat for actuation by the user's thighs, or on the back of the cushion or chair for actuation by shoulders.

In FIG. 4, the two-dimensional (2D), (x, y) array of sensors 281a-d are configured to sense a change in weight distribution in at least two (x, y) dimensions. As the user moves, the sensors 281a-d detect a relative change (increase or decrease) in weight (force/pressure) and thus an overall change in weight distribution can be determined. For example, for a single axis change in weight distribution, if the force/pressure sensed by the first sensor 281a at 12 o'clock increases and the force/pressure sensed by the second sensor 281b on the same (y) axis at 6 o'clock decreases, then the user has shifted their weight forward on that (y) axis, from the back of the cushion to the front of the cushion (e.g. by leaning forward). Similarly, if the force/pressure sensed by the third sensor 281c at 9 o'clock increases and the force/pressure sensed by the fourth sensor 281d at 3 o'clock on the same (x) axis decreases, then the user has shifted their weight backwards on the (x) axis, from the right of the cushion to the left of the cushion (e.g. by leaning left). Of course, multi-axis movements can similarly be detected as combinations of increasing and decreasing sensed force/pressure in multiple axes.

In some embodiments, the input device 280 further comprises a rotational sensor (not shown) for detecting rotation of the user and/or the input device 280. Such a rotational sensor can provide additional data about the user's movement e.g. about a third, z-axis, which can additionally be provided to the computing system 210. An example of such a sensor may be a potentiometer in a support column of a chair, or a gyroscope.

As detailed above, the input device transmitter 285 is configured to transmit a signal based on the sensed change in weight distribution for use in a virtual joystick input 241 to a computing system. The signal based on the sensed change in weight distribution is received by the internal or external controller 260 and the controller 260 determines a virtual joystick input 241 based thereon and provides it to the computing system 210.

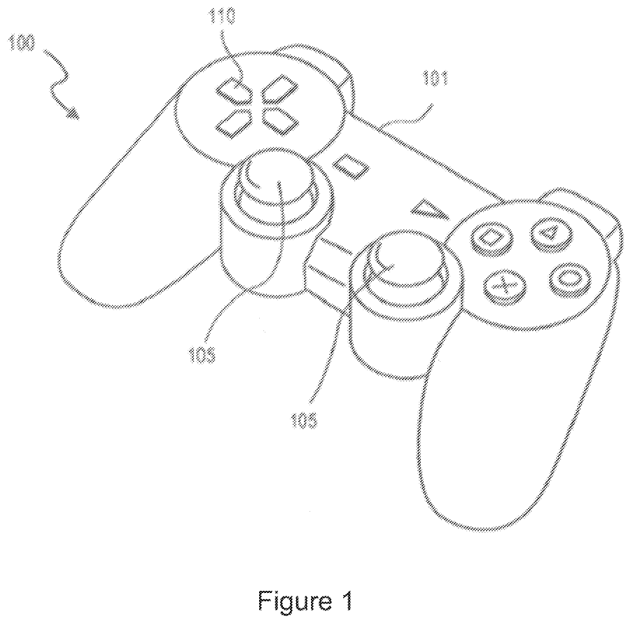

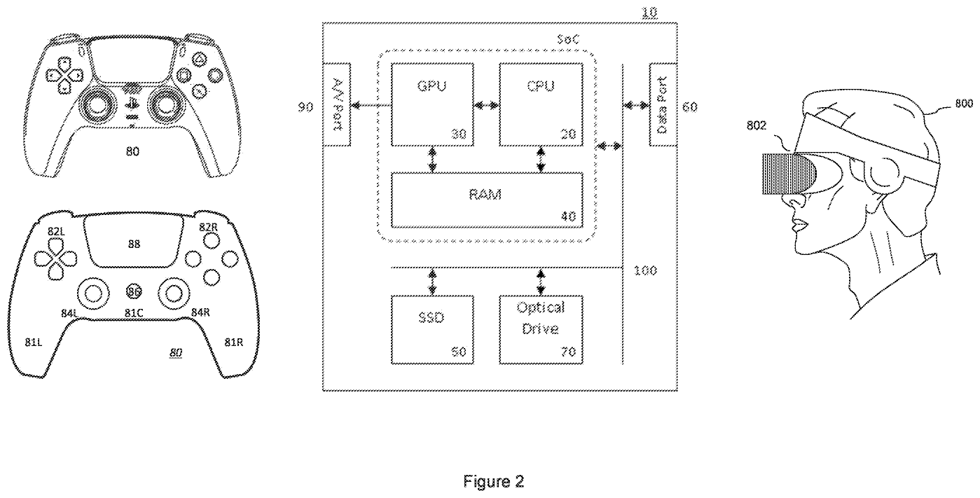

In some embodiments, the virtual joystick input 241 comprises one, two (x, y) or three dimensional (x, y, z) directional input 241. The input 241 may be an analogue directional input, or a digital directional input. An analogue directional input mirrors the functionality of the thumb sticks of existing controllers described above with reference to FIGS. 1 and 2. For digital inputs, these can be simple binary directional inputs, e.g. providing simple 4 cardinal direction d-pad functionality 241a-241d as per the left button group 82L of FIG. 2 (i.e. up/down/left/right 241a-241d) or multi-axis combined inputs, e.g. including intercardinal (ordinal) directions bisecting the above, totaling 8 possible directions. Generally, the virtual joystick input 241 may comprise a two-dimensional (x, y) digital directional input having 2^{N} possible directions, preferably where N lies between 1 and 8 (where 2⁸=256 different directions), where higher N-values increase accuracy and more closely approximate analogue control.

Similarly, the virtual joystick input 241 may comprise a two-dimensional (x, y) digital directional input having 2^{N} possible magnitudes, again preferably where N lies between 1 and 8 (where 2⁸=256 different magnitudes), where higher N-values increase accuracy and more closely approximate analogue control. For digital magnitude control, there may be a number of different predetermined magnitude thresholds, e.g. for which there is a first distinct input magnitude (e.g. 50%) when the data indicative of the applied weight exceeds a first threshold, and a second distinct input magnitude (e.g. 100%) when the data indicative of the applied weight exceeds a second threshold, and so on. The thresholds may be different depending on the type of sensor used, or the user's characteristics. A calibration process may measure a range of typical forces/pressures applied by a user during use and appropriately set the thresholds. Alternatively, the thresholds can be set in accordance with a user's preference or their profile (for example, setting lower thresholds for a child than an adult). Dependent on the application, N being 4 or higher (for magnitude and/or direction inputs) might be considered sufficient to emulate analogue directional control. In some embodiments, the joystick input further comprises a further (non-directional) input, e.g. an analogue action input or a digital action input.

The signal is interpreted as a virtual joystick input 241 by the controller 260. In FIG. 3, the controller 260 is a tethered intermediary controller 260 in FIG. 3. In other embodiments, the computing system 210 has the controller 260 therein, or the signal can be processed within the input device 280, by the input device 280 comprising the controller 260. If the input device 280 comprises the controller 260 or the controller is an intermediary controller 260, then the controller 260 determines the virtual joystick input 241 based on the signal and then transmits the virtual joystick input 241 to the computing system 210. If the computing system 210 has the controller 260 therein, then the controller 260 determines the virtual joystick input 241 based on the signal and then applies the virtual joystick input 241 to the computing system 210 directly.

More generally, the input device 280 may either transmit raw signal data, or processed data resembling a controller input, to an intermediate controller 260 (for example a DualSense® handheld controller, or a processor). If the data is processed to resemble controller input, the input device 280 typically comprises a processor corresponding to that of a controller 260 (or the relevant part thereof) required to perform that processing. The controller 260 may then transmit the input, typically in lieu of one of its own equivalent inputs, to the computing system 210, optionally processing raw signal data as needed to generate such a controller input. In this way the input(s) from the input device 280 are integrated into the input stream from a controller in a manner transparent to the computing device 210.

Alternatively or in addition, the input device 280 may comprise the controller processing required to enable it to process and transmit the controller input directly to the computing system 210. The computing system may then optionally integrate this with other inputs (such as those from a separate DualSense® handheld controller) to treat the inputs as if from a single controller, or may treat the inputs from the input device 280 as from a separate controller.

In either case, the effect is that the input device 280 acts to provide some or all of the inputs typically provided by a conventional controller, either as part of that controller's own transmission when it acts as an intermediary to the computing device 210, or separately; and the input device 280 is treated either as a replacement part of another controller, or as a controller in its own right.

Parameters of the detection of changes in weight distribution can be customised to suit the user and advantageously, the input device 280 or controller 260 may be configured to calibrate the input device 280 for a given user. In particular, the number and/or arrangement of the sensors 281 can be determined to suit requirements: for example, a mattress input device 280 might require a 2D array of sensors that is rectangular, to accommodate a user lying thereon. Of course, increasing the number of sensors 281 can increase the granularity of sensed movement changes.

It should be appreciated that the system may not necessarily need pre-calibration and/or may auto-calibrate. For example, the FIG. 4 arrangement with a 2D array of sensors 281a-d is configured to sense a change in weight distribution in at least two (x, y) dimensions. When the user first positions themself (e.g. sits) on the device 280, then this can automatically be set as a neutral reference position for each sensor 281. If, for example, force sensors are used, then system can measure the total force experienced and equate this total force to the user's weight, and then apply predetermined thresholds for changes in weight distribution e.g. if more than 50% of the measured force at one sensor shifts from one side of the neutral dead zone (e.g. on sensor 281c) to the opposing side of the neutral dead zone (i.e. to sensor 281d), then this could be considered a full magnitude directional input 241d. Accordingly, as the user moves, the force sensors 281a-d detect a relative change (increase or decrease) in force and thus an overall change or shift in weight distribution can be determined and translated to a virtual joystick input 241 without manual calibration.

Nevertheless, advantageously, in some embodiments, further functionality may include the overall system, the input device 280 or the controller 260 being configured to: (a) set a neutral or reference weight distribution as a neutral position X₀, Y₀ of the virtual joystick; and/or (b) set one or more extreme weight distributions as one or more extreme positions of the virtual joystick; and/or (c) map a particular sensed change in weight distribution to a particular virtual joystick input direction or action; and/or (d) adjust an overall sensitivity of changes in weight distribution; and/or (f) adjust a sensitivity of one or more of the sensors 281; and/or (g) adjust a dead zone threshold for detecting the changes in weight distribution.

In particular, setting a neutral/reference position allows the user to set a comfortable reference position for setting up the system, which might differ to their first position when on the input device 280, particularly bearing in mind that the user might have limited movement. Equally, setting one or more extremes allows the user to set customised extremes, so that they do not need to over-reach (or over-lean) to provide that input. This is in contrast to standard controllers, which typically only interpret extreme positions of the joystick as the physical limitation of movement of the joystick. Moreover, the user can preferably map particular changes to particular directions, which might be more comfortable. Many control systems allow the inversion of a single input axis (e.g. moving a thumb stick forward to generate a downward input and backwards to generate an upwards input), but the present invention provides further customisability to suit movement impaired users and can allow any shift in weight distribution to be mapped to any particular input direction.

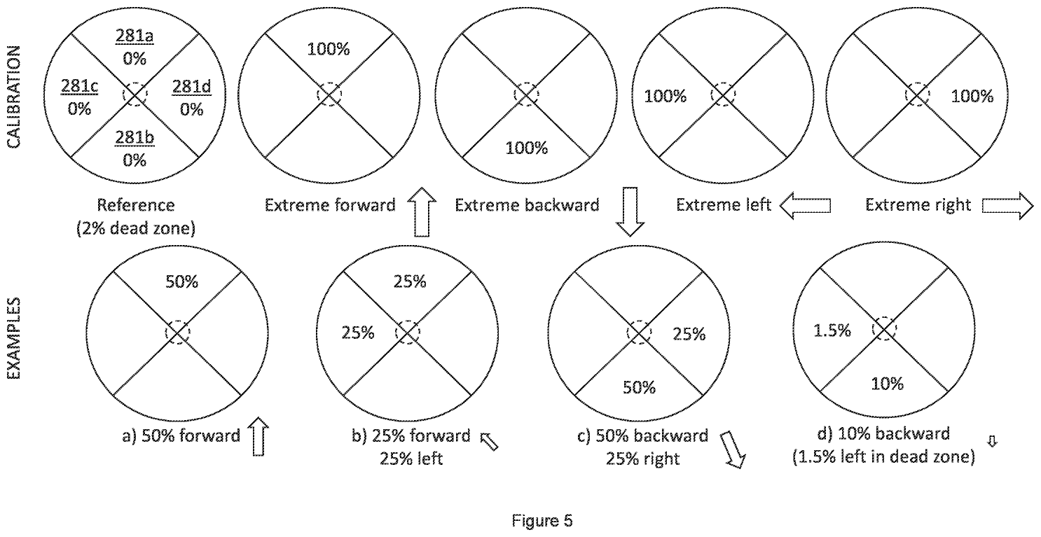

In one embodiment, described further with reference to FIG. 5 below, the user configures weight distributions for extreme positions in 2 (x, y) axes, and the system maps the sensors 281a to 281d to corresponding input directions i.e. forward 241a, backwards 241b, left 241c and right 241d respectively, interpolating intervening sensed values to establish intermediate inputs.

In some embodiments, the user can adjust the overall sensitivity of the system, for example if they are experiencing more limited movement than usual, then they can increase overall sensitivity, so smaller changes in weight distribution provide larger changes in input magnitude; and/or extreme positions require less extreme weight distributions. For example, doubling the overall sensitivity can halve the extreme pressures required for maximum input magnitude.

In some embodiments, the overall system 200 is configurable to adjust a sensitivity of one or more of the sensors 281a-281d. For example, a particular user might have more limited movement in one direction or in one sensing region, and hence the sensitivity there can be increased selectively (to register smaller inputs as intended changes in weight distribution) or conversely, be reduced or disabled (i.e. set the sensitivity thereof to zero). This effectively allows the user to customise the weighting of sensors, at a zone-based or individual level, as desirable.

In some embodiments, the user can set and/or adjust a dead zone threshold for detecting the changes in weight distribution. This allows the user to predefine a limited amount of movement (such as say 1%, 2.5%, 5% or 10% from the reference position/weight distribution to any one extreme position/weight distribution) that is effectively ignored or filtered out, providing a low-pass filter for movement/weight distribution change. Alternatively, the user may predefine a zone, such as a particular sub region 284 on the input device 280, within which movement/weight distribution change is not detected or ignored, i.e. that does not result in a joystick input 241 to the computing system 210, thus an input is only determined or provided to the computing system 210 if the user changes their weight distribution in or moves outside of the dead zone region 284.

FIG. 5 illustrates a schematic diagram of how the system 200 of FIGS. 3 and 4 may be calibrated and used to provide an input in accordance with an embodiment of the present disclosure. In this example embodiment, the input device 280 comprises 4 pressure or force sensors 281a-281d arranged in a 2D array as shown in FIGS. 3 and 4, effectively comprising one sensor for detecting changes in each one of 4 cardinal directions in two axes (x, y). In this simple embodiment, one sensor is used to detect a change in each cardinal direction only; and sensors sensing decreasing force/pressure are ignored, so only sensors sensing increasing force/pressure are considered to indicate the directional intent of the user. In more complex but more accurate systems, more than one sensor may be used for each cardinal direction and/or additional sensors 281 may be used for intercardinal (ordinal) directions bisecting each cardinal direction, totaling 8 possible directions for the system, and so on with increasing divisions enhancing accuracy. Moreover, in further embodiments, sensors sensing decreasing force/pressure may be considered and/or sensor data can be correlated, for example neighbouring sensors and/or opposing sensors may be paired and their signals considered collectively, to gain further insight into the user's movement and hence directional and/or magnitude intent. In yet further embodiments, the controller 260 can be configured to determine an absolute centre of gravity of the user based on the sensor data and translate a directional shift of the user's centre of gravity to a directional virtual joystick input 241.

In FIG. 5, the system is first calibrated by the user setting a reference weight distribution, which acts as a datum for subsequent sensed changes in weight distribution. This force/pressure signal can then be considered as 0% input, reflecting the user's rest or neutral position. The user then sets the extrema for each sensor 281: the user moves to extreme positions (extreme forward, backward, left and right) to reflect the furthest they can (comfortably) move and these are stored as maximum (100%) force/pressure signals for each sensor. The signals may be stored as raw signals (e.g. voltages) or e.g. converted to digital force/pressure measurements.

Once calibrated, the system is ready for use. As described with reference to FIGS. 3 and 4, the controller 260 is configured to receive a signal from the sensors 281 and determine the virtual joystick input 241 based on the signals.

FIG. 5 shows various sensed changes in weight distribution and the resultant outputs from the controller 260.

In the first example a), the first sensor 281a indicates an increased sensed force/pressure of 50%, i.e. halfway between the reference forward force/pressure and extreme forward force/pressure, indicating a forward shift in the user's weight distribution. No increase in force/pressure is registered by the other sensors 281b-d, so these are ignored. Accordingly, the controller 260 determines a 50% forward joystick input 241 and provides this to the computing system 210.

In the second example b), the first sensor 281a and the third sensor 281c each indicate an increased force/pressure of 25%, i.e. a quarter way toward their respective extreme force/pressure from their respective reference force/pressure. No increase in force/pressure is registered by the other sensors 281b, 281d, so these are ignored. Accordingly, the controller 260 determines a 25% forward and 25% left joystick input 241 and provides this to the computing system 210.

In the third example c), the second sensor 281b and fourth sensor 281d indicate increased force/pressure of 50% and 25% respectively, i.e. 50% and 25% toward their respective extreme force/pressure from their respective reference force/pressure. No increase in force/pressure is registered by the other sensors 281a, 281c, so these are ignored. Accordingly, the controller 260 determines a 50% backward and 25% right joystick input 241 and provides this to the computing system 210.

In the fourth example d), the second sensor 281b and the third sensor 281c indicate increased force/pressure of 10% and 1.5% respectively, i.e. 10% and 1.5% toward their respective extreme force/pressure from their respective reference force/pressure. No increase in force/pressure is registered by the other sensors 281a, 281d, so these are ignored. In these examples, the dead zone threshold is set to 2%, thus any movement within 2% of the difference between the reference and extreme force/pressure for a given sensor 281 are ignored. The force/pressure increase sensed by the third sensor 281c is 1.5%, thus falls under the dead zone threshold and so is ignored. Accordingly, the controller 260 determines a 10% backward joystick input 241 and provides this to the computing system 210.

Advantageously, in some embodiments, changes to the user's weight distribution in the dead zone might not be applied as an immediate input, but may optionally be analysed to anticipate future potential input. For example, if the force/pressure distribution indicates increasing force/pressure in a direction consistent with the current displacement direction, then this could indicate that further displacement is imminent. This may be used to initialise in-game events relevant to an outcome caused by such further displacement, such as loading audio associated with a crash. Meanwhile, evenly distributed force/pressure could indicate an intention to maintain the current displacement. This may be used for example to initialise game features associated with a steady state in-game, such as displaying messages, or activating a reticule or the like. Finally, a force/pressure distribution indicating more force/pressure in a direction consistent with changing or reversing the direction of current displacement may be detected before such a change of displacement actually occurs, and depending upon the amount of force/pressure, may be indicative of the extent of the change likely to occur in the near future. In this case, this may be used to initialise game features associated with avoiding an imminent threat, or game assets associated with choosing a different game path or the like, earlier than if the system had to wait for the displacement to actually occur. This can improve in-game responsiveness and stability.

In some embodiments, one or more of the sensors 281 are located on, embedded in or located underneath a surface of the device on which the user is positioned in use. In some embodiments, one or more of the sensors 281 are movable with respect to the input device 280, allowing the user to reposition sensors to suit their movement, which may be limited. In some embodiments, the sensors 281 comprise one or more movable sensors 281 such as glute sensors 281 which are configured to detect a change weight distribution of the user when they tense their glutes, to provide an action or directional input to the computing system 210.

As outlined above, in use, the user is positioned on the input device 280. In normal use, the user remains in contact with at least a majority of the sensors 281 and changes the distribution of their weight across the sensors 281, shifting their centre of gravity, which can be detected or determined and translated into a joystick input. However, in some embodiments, some sensors may be provided at extreme positions which are not necessarily routinely activated. Accordingly, in further embodiments, the user remains in contact with at least 25%, 50% or 75% of the plurality of sensors 281 as they move and shift their weight distribution on the input device 280. Thus, in some embodiments, at least 25%, 50% or 75% of the plurality of sensors provide non-zero input in use, as the user moves on the input device 280. The sensors preferably provide a non-binary output, unlike, for example, binary proximity sensors which provide only a binary output (activated/not; 1/0).

In some embodiments, other peripherals may be provided for interacting with the computing system 210, via either wired or wireless means and these may include a keyboard, a mouse, a media controller, and/or a headset. The headset may comprise one or two speakers and optionally a microphone.

In some embodiments, the system (i.e. any of the input device 280, controller 260 or the computing system 210) may be configured to determine the user's total weight, e.g. by summing the total force exerted on the sensors 281 by the user. Such total weight data may be used to detect if the user is no longer positioned on the input device 280 and can be used as an input, e.g. to pause software running on the system 210, provide an action input or trigger an alarm.

For example, a change in total weight above/below a threshold may be used as an additional input, e.g. the user could partially or fully raise from the input device 280 to provide a whole-device input, reducing the total weight e.g. relatively by >25, >50, >75%, >80%, >85%, >90% or >95%, or an absolute value, which may be detected and associated with an action such as a button input (e.g. user has gotten up and left, zero or negligible weight registered pauses game), or the user could pick up an object to increase the total force on the input device 280 e.g. relatively by >2%, >5% or >10%, or an absolute value, to provide a further input such as an action button.

In some embodiments, the system may be a play mat for an infant or toddler, and/or provide an interactive toy—for example, if the user is a young child, baby or has a particular disability then if the system detects a change in total weight above or below an absolute or relative threshold (e.g. baby carrying a toy drops toy or pacifier and baby rolls off mat but toy or pacifier remains, exerting a small weight force, but total weight suddenly drops by >90% or >95%, or alternatively substantially zero weight (e.g. user has gotten up and left, zero or negligible weight registered) then an alarm may be triggered.

The total weight data may also be used for health tracking, e.g. monitoring, logging and/or reporting the user's weight over time, and/or identifying/detecting the user based on their total weight or weight distribution and applying a customised user profile (such as configuration or calibration settings, e.g. thresholds and dead zones as discussed above).

It will be appreciated that the above methods may be carried out on conventional hardware (such as that described previously herein) suitably adapted as applicable by software instruction or by the inclusion or substitution of dedicated hardware. Thus, the required adaptation to existing parts of a conventional equivalent device may be implemented in the form of a computer program product comprising processor implementable instructions stored on a non-transitory machine-readable medium such as a floppy disk, optical disk, hard disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

Protection may be sought for any features disclosed in any one or more published documents referenced herein in combination with the present disclosure.

Embodiments of the present disclosure may be implemented in accordance with any one or more of the following numbered clauses:

1. An input device for controlling a computing system, comprising:
one or more sensors configured to sense a change in weight distribution of a user positioned on the input device in use; and
a transmitter configured to transmit a signal based on the sensed change in weight distribution, for use in a virtual joystick input to a computing system.

2. An input device for controlling a computing system, comprising:
a. one or more sensors configured to sense a change in weight distribution of a user positioned on the input device in use; and
b. a controller configured to determine a virtual joystick input based on the sensed change in weight distribution and provide the virtual joystick input to a computing system.

3. The input device of clause 1 or 2, wherein the one or more sensors:
a. are configured to sense a change in weight distribution in at least two (x, y) dimensions; and/or
b. comprise a two-dimensional (x, y) array of sensors; and/or
c. are located on, embedded in or located underneath a surface of the device on which the user is positioned in use; and/or
d. comprise one or more sensors which are movable with respect to the input device;
e. comprise one or more force sensors;
f. comprise one or more pressure sensors; and/or
g. comprise one or more: capacitance pressure sensors; resistance pressure sensors; piezoresistive pressure sensors; piezoelectric pressure sensors; optical pressure sensors; and/or elastoresistive pressure sensors.

4. The input device of any preceding clause, further comprising a rotational sensor for detecting rotation of the user and/or the input device.

5. The input device of any preceding clause, further comprising one or more additional input devices, actuators or haptic feedback devices.

6. A controller for controlling a computing system based on a signal from an input device, the controller configured to:
a. receive a signal based on a sensed change in weight distribution from an input device comprising one or more sensors configured to sense a change in weight distribution of a user positioned on the input device in use;
b. determine a virtual joystick input based on the signal; and
c. provide the virtual joystick input to the computing system.

7. The input device of any of clauses 1-5, comprising the controller of clause 6.

8. The controller of clause 6, wherein:
a. the input device comprises the controller; or
b. the computing system comprises the controller; or
c. the controller is an intermediary controller between the input device and the computing system.

9. The input device of clause 2 or any clause dependent thereon, or the controller of any of clauses 6-8, wherein the controller is configured to:
a. determine a two-dimensional (x,y) directional virtual joystick input; and/or
b. determine the virtual joystick input based on the sensed change in weight distribution relative to a reference weight distribution.

10. The input device of clause 2 or any clause dependent thereon, or the controller of any of clauses 6-9, wherein the virtual joystick input comprises:
a. one, two or three dimensional directional input; and/or
b. analogue directional input or digital directional input; and/or optionally further comprising:
c. an analogue action input or a digital action input.

11. The input device of clause 2 or any clause dependent thereon, or the controller of any of clauses 6-10, wherein:
a. the virtual joystick input comprises two-dimensional (x, y) digital directional input having 2^{N} possible directions, preferably where N lies between 1 and 8; and/or
b. the virtual joystick input comprises two-dimensional (x, y) digital directional input having 2^{N} possible magnitudes, preferably where N lies between 1 and 8.

12. The input device of clause 2 or any clause dependent thereon, or the controller of any of clauses 6-11, wherein determining the virtual joystick input comprises:
a. determining an increase or decrease in weight distribution in one or more directions relative to a reference weight distribution; and
b. mapping the relative increase or decrease in weight distribution in one or more directions to a virtual joystick input direction or action.

13. The input device of clause 2 or any clause dependent thereon, or the controller of any of clauses 6-12, wherein the controller is configured to filter and ignore small changes in weight distribution falling under a dead zone threshold.

14. The input device of clause 2 or any clause dependent thereon, or the controller of any of clauses 6-13, wherein:
a. the one or more sensors are configured to sense a change in weight distribution in at least two (x, y) dimensions; and determining the virtual joystick input comprises:
b. determining an increase or decrease in weight distribution in two (x, y) dimensions relative to a reference weight distribution; and
c. mapping the increase or decrease in weight distribution in two (x, y) dimensions to a two-dimensional (x, y) analogue virtual joystick input direction.

15. The input device or controller of any preceding clause, wherein the input device or controller is configured to calibrate the input device for a user, comprising the input device or controller being configured to:
a. set a neutral or reference weight distribution as a neutral position of the virtual joystick; and/or
b. set one or more extreme weight distributions as one or more extreme positions of the virtual joystick; and/or
c. map a particular sensed change in weight distribution to a particular virtual joystick input direction or action; and/or
d. adjust an overall sensitivity of changes in weight distribution; and/or
e. adjust a sensitivity of one or more of the sensors; and/or
f. adjust a dead zone threshold for detecting the changes in weight distribution.

16. A mat, a seat or bed or any component thereof or any fitting therefor, comprising the input device of any preceding input device clause, for detecting the change in weight distribution of a user positioned thereon in use; optionally further comprising the controller of any preceding controller clause.

17. The seat or bed component or fitting of clause 16, wherein the component or fitting comprises a seat pan, seat pad, seat leg, seat wheel, bed frame, bed frame leg, bed frame wheel or a mattress.

18. A system or entertainment system comprising:
a. the input device of any of preceding input device clause; and/or
b. the controller of any of controller clauses 6-15; and/or
c. the computing system.

19. The system of clause 18:
a. wherein the computing system comprises the controller and the computing system controller is configured to:
(i) receive the signal from the input device comprising the one or more sensors configured to sense the change in weight distribution of the user positioned on the input device in use;
(ii) determine the virtual joystick input based on the received signal; and
(iii) apply the virtual joystick input to the computing system; or
b. wherein the input device comprises the controller and the input device controller is configured to:
(i) receive the signal from the input device comprising the one or more sensors configured to sense the change in weight distribution of the user positioned on the input device in use;
(ii) determine the virtual joystick input based on the received signal; and
(iii) transmit the virtual joystick input to the computing system; or
c. the controller is an intermediary controller and is configured to:
(i) receive the signal from the input device comprising the one or more sensors configured to sense the change in weight distribution of the user positioned on the input device in use;
(ii) determine the virtual joystick input based on the received signal; and
(iii) transmit the virtual joystick input to the computing system.

20. A method for controlling a computing system based on a change in weight distribution of a user, comprising:
a. at an input device having one or more sensors configured to sense a change in weight distribution of a user positioned on the input device in use, sensing a change in weight distribution of a user positioned on the input device in use; and
b. transmitting a signal based on the sensed change in weight distribution, for use in a virtual joystick input to a computing system.

21. The method of clause 20, further comprising:
a. determining a virtual joystick input based on the sensed change in weight distribution; and
b. providing the virtual joystick input to the computing system.

22. A method of determining a virtual joystick input based on a change in weight distribution of a user, for controlling a computing system, comprising:
a. receiving a signal based on a sensed change in weight distribution from an input device comprising one or more sensors configured to sense a change in weight distribution of a user positioned on the input device in use;
b. determining a virtual joystick input based on the signal; and
c. providing the virtual joystick input to the computing system.

23. The method of clause 22, wherein:
a. the one or more sensors are configured to sense a change in weight distribution in at least two (x, y) dimensions; and determining the virtual joystick input comprises:
b. determining an increase or decrease in weight distribution in two (x, y) dimensions relative to a reference weight distribution; and
c. mapping the increase or decrease in weight distribution in two (x, y) dimensions to a two-dimensional (x, y) analogue virtual joystick input direction.

24. The method of any of clauses 21-23, wherein:
a. the input device comprises a controller for determining the virtual joystick input and providing the virtual joystick input to the computing system; or
b. the computing system comprises a controller for determining the virtual joystick input and providing the virtual joystick input to the computing system; or
c. the system comprises an intermediary controller between the input device and the computing system, for determining the virtual joystick input and providing the virtual joystick input to the computing system.

25. A computer-readable medium having computer executable instructions configured to cause a computer system to perform the method of any one of clauses 20-24.

1. An input device for controlling a computing system, comprising:
one or more sensors configured to sense a change in weight distribution of a user positioned on the input device in use; and
a transmitter configured to transmit a signal based on the sensed change in weight distribution, for use in a virtual joystick input to a computing system.

2. The input device of claim 1, wherein the one or more sensors:
(a) are configured to sense a change in weight distribution in at least two (x, y) dimensions; and/or
(b) comprise a two-dimensional (x, y) array of sensors; and/or
(c) are located on, embedded in or located underneath a surface of the device on which the user is positioned in use; and/or
(d) comprise one or more sensors which are movable with respect to the input device;
(e) comprise one or more force sensors;
(f) comprise one or more pressure sensors; and/or
(g) comprise one or more: capacitance pressure sensors; resistance pressure sensors;
piezoresistive pressure sensors; piezoelectric pressure sensors; optical pressure sensors; and/or elastoresistive pressure sensors.

3. The input device of claim 1, further comprising a rotational sensor for detecting rotation of the user and/or the input device.

4. The input device of claim 1, further comprising one or more additional input devices, actuators or haptic feedback devices.

5. The input device of claim 1, comprising a controller for controlling a computing system based on a signal from an input device, the controller configured to:
(a) receive a signal based on a sensed change in weight distribution from an input device comprising one or more sensors configured to sense a change in weight distribution of a user positioned on the input device in use;
(b) determine a virtual joystick input based on the signal; and
(c) provide the virtual joystick input to the computing system.

6. A controller for controlling a computing system based on a signal from an input device, the controller configured to:
(a) receive a signal based on a sensed change in weight distribution from an input device comprising one or more sensors configured to sense a change in weight distribution of a user positioned on the input device in use;
(b) determine a virtual joystick input based on the signal; and
(c) provide the virtual joystick input to the computing system.

7. The controller of claim 6, wherein:
(d) the input device comprises the controller; or
(e) the computing system comprises the controller; or
(f) the controller is an intermediary controller between the input device and the computing system.

8. An input device for controlling a computing system, comprising:
(a) one or more sensors configured to sense a change in weight distribution of a user positioned on the input device in use; and
(b) a controller configured to determine a virtual joystick input based on the sensed change in weight distribution and provide the virtual joystick input to a computing system.

9. The input device of claim 8, wherein the controller is configured to:
(c) determine a two-dimensional (x,y) directional virtual joystick input; and/or
(d) determine the virtual joystick input based on the sensed change in weight distribution relative to a reference weight distribution.

10. The input device of claim 8, wherein the virtual joystick input comprises:
(c) one, two or three dimensional directional input; and/or
(d) analogue directional input or digital directional input; and/or optionally further comprising:
(e) an analogue action input or a digital action input.

11. The input device of claim 8, wherein:
(c) the virtual joystick input comprises two-dimensional (x, y) digital directional input having 2^{N} possible directions, preferably where N lies between 1 and 8; and/or
(d) the virtual joystick input comprises two-dimensional (x, y) digital directional input having 2^{N} possible magnitudes, preferably where N lies between 1 and 8.

12. The input device of claim 8, wherein determining the virtual joystick input comprises:
(c) determining an increase or decrease in weight distribution in one or more directions relative to a reference weight distribution; and
(c) mapping the relative increase or decrease in weight distribution in one or more directions to a virtual joystick input direction or action.

13. The input device of claim 8, wherein the controller is configured to filter and ignore small changes in weight distribution falling under a dead zone threshold.

14. The input device of claim 8, wherein:
(c) the one or more sensors are configured to sense a change in weight distribution in at least two (x, y) dimensions; and
determining the virtual joystick input comprises:
(d) determining an increase or decrease in weight distribution in two (x, y) dimensions relative to a reference weight distribution; and
(e) mapping the increase or decrease in weight distribution in two (x, y) dimensions to a two-dimensional (x, y) analogue virtual joystick input direction.

15. The input device of claim 8, wherein the input device is configured to calibrate the input device for a user, comprising the input device or controller being configured to:
(c) set a neutral or reference weight distribution as a neutral position of the virtual joystick; and/or
(d) set one or more extreme weight distributions as one or more extreme positions of the virtual joystick; and/or
(e) map a particular sensed change in weight distribution to a particular virtual joystick input direction or action; and/or
(f) adjust an overall sensitivity of changes in weight distribution; and/or
(g) adjust a sensitivity of one or more of the sensors; and/or
(h) adjust a dead zone threshold for detecting the changes in weight distribution.

16. A mat, seat bed, any component thereof, or any fitting therefor, comprising:
an input device for controlling a computing system, comprising:
(a) one or more sensors configured to sense a change in weight distribution of a user positioned on the input device in use; and
(b) a controller configured to determine a virtual joystick input based on the sensed change in weight distribution and provide the virtual joystick input to a computing system,
wherein the input device operates to detect a for detecting the change in weight distribution of a user positioned on the mat, seat bed, component thereof or any fitting therefore.

17. The mat, seat, bed, component or fitting of claim 16, comprising a seat pan, seat pad, seat leg, seat wheel, bed frame, bed frame leg, bed frame wheel or a mattress.

18. A method for controlling a computing system based on a change in weight distribution of a user, comprising:
(a) at an input device having one or more sensors configured to sense a change in weight distribution of a user positioned on the input device in use, sensing a change in weight distribution of a user positioned on the input device in use; and
(b) transmitting a signal based on the sensed change in weight distribution, for use in a virtual joystick input to a computing system.
